(19) United States
(12) Patent Application Publication
(10) Pub. No.: US 2002/0178762 A1
(43) Pub. Date: Dec. 5, 2002

(54) Methods and apparatus for forming and controlling the diameter of drawn optical glass fiber

(76) Inventors: John D. Foster, Wilmington, NC (US); Daniel W. Hawtof, Painted Post, NY (US); David A. Highsmith, Hampstead, NC (US); Jennifer L. Tarplee, Wilmington, NC (US)

Correspondence Address: MYERS BIGEL SIBLEY & SAJOVEC, PO BOX 37428, RALEIGH, NC, 27627, US

(21) Appl. No.: 09/872,837

(22) Filed: Jun. 1, 2001

(51) Int. Cl. C03B 37/025

(52) U.S. Cl. 65/424

(57) ABSTRACT

An apparatus for forming optical fiber from a glass preform using a forming gas includes a draw furnace having first and second opposed ends. The draw furnace defines an exit opening at the second end and a furnace passage extending between the first and second ends. A control tube extends through the exit opening of the draw furnace. The control tube defines first and second opposed tube openings and a tube passage extending between the first and second tube openings. The control tube includes a first tube section and a second tube section. The first tube opening and the first tube section are disposed in the furnace passage and cooperate with the passage of the draw furnace to form a buffer cavity adjacent the control tube. The second tube opening and the second tube section are disposed downstream of the draw furnace. The tube passage includes an inner diameter. The inner diameter of the tube passage is less than an inner diameter of the furnace passage. The draw furnace and the control tube are adapted such that substantially all of the forming gas enters the furnace passage upstream of the first tube opening and exits the apparatus through the control tube. A method for forming an optical fiber includes providing an apparatus as described above. An optical glass fiber is drawn through the furnace passage and the control tube. During the step of drawing the optical glass fiber, a forming gas is flowed through the furnace passage and the control tube such that substantially all of the forming gas enters the furnace passage upstream of the first tube opening and exits the apparatus through the control tube.

### FIELD OF THE INVENTION

The present invention relates to methods and apparatus for forming optical glass fiber, and, more particularly, to methods and apparatus for forming and controlling the diameter of drawn optical glass fiber.

### BACKGROUND OF THE INVENTION

According to known processes, optical glass fiber may be drawn from a glass preform or blank using a draw furnace. The draw furnace has a chamber that is heated, for example, by induction heating, so that the lower tip of the preform is melted and the optical fiber is drawn from the tip. As the fiber descends from the tip, it is further drawn so that its diameter is progressively reduced. Transients may occur as the molten fiber is drawn so that variations or non-uniformities are created in the fiber. These non-uniformities may negatively affect the properties of the optical fiber, for example, by creating inconsistencies along the length of the fiber. Variations in the fiber diameter may also impact downstream processes, such as fiber coating, resulting in inferior fiber product and/or process stoppage. Hence, improved optical glass fiber diameter control is desirable for process stability, quality control and equipment utilization improvement.

### SUMMARY OF THE INVENTION

Embodiments of the present invention include an apparatus for forming optical fiber from a glass preform using a forming gas includes a draw furnace having first and second opposed ends. The draw furnace defines an exit opening at the second end and a furnace passage extending between the first and second ends. A control tube extends through the exit opening of the draw furnace. The control tube defines first and second opposed tube openings and a tube passage extending between the first and second tube openings. The control tube includes a first tube section and a second tube section. The first tube opening and the first tube section are disposed in the furnace passage and cooperate with the passage of the draw furnace to form a buffer cavity adjacent the control tube. The second tube opening and the second tube section are disposed downstream of the draw furnace. The tube passage includes an inner diameter. The inner diameter of the tube passage is less than an inner diameter of the furnace passage. The draw furnace and the control tube are adapted such that substantially all of the forming gas enters the furnace passage upstream of the first tube opening and exits the apparatus through the control tube.

According to further embodiments of the present invention, a method for forming an optical fiber includes providing an apparatus. The apparatus includes a draw furnace having first and second opposed ends. The draw furnace defines an exit opening at the second end and a furnace passage extending between the first and second ends. A control tube extends through the exit opening of the draw furnace. The control tube defines first and second tube openings. The control tube includes a first tube section and a second tube section. The first tube opening and the first tube section are disposed in the furnace passage and cooperate with the furnace passage to form a buffer cavity adjacent the control tube. The second tube opening and the second tube section are disposed downstream of the draw furnace. The tube passage includes an inner diameter. The inner diameter of the tube passage is less than an inner diameter of the furnace passage. An optical glass fiber is drawn through the furnace passage and the control tube. During the step of drawing the optical glass fiber, a forming gas is flowed through the furnace passage and the control tube such that substantially all of the forming gas enters the furnace passage upstream of the first tube opening and exits the apparatus through the control tube.

Further features and advantages of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

The accompanying drawing, which is incorporated in and constitutes a part of the specification, illustrates embodiments of the invention and, together with the description, serves to explain principles of the invention.

FIG. 1 is a schematic, cross-sectional view of a fiber forming apparatus according to embodiments of the present invention;

FIG. 2 is a graph illustrating variations in the diameter of an optical fiber over time, wherein the fiber is drawn using an apparatus not including a control tube according to the present invention; and

FIG. 3 is a graph illustrating variations in the diameter of an optical fiber over time, wherein the fiber is drawn using an apparatus including a control tube according to an embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. In the figures, layers, components or regions may be exaggerated for clarity.

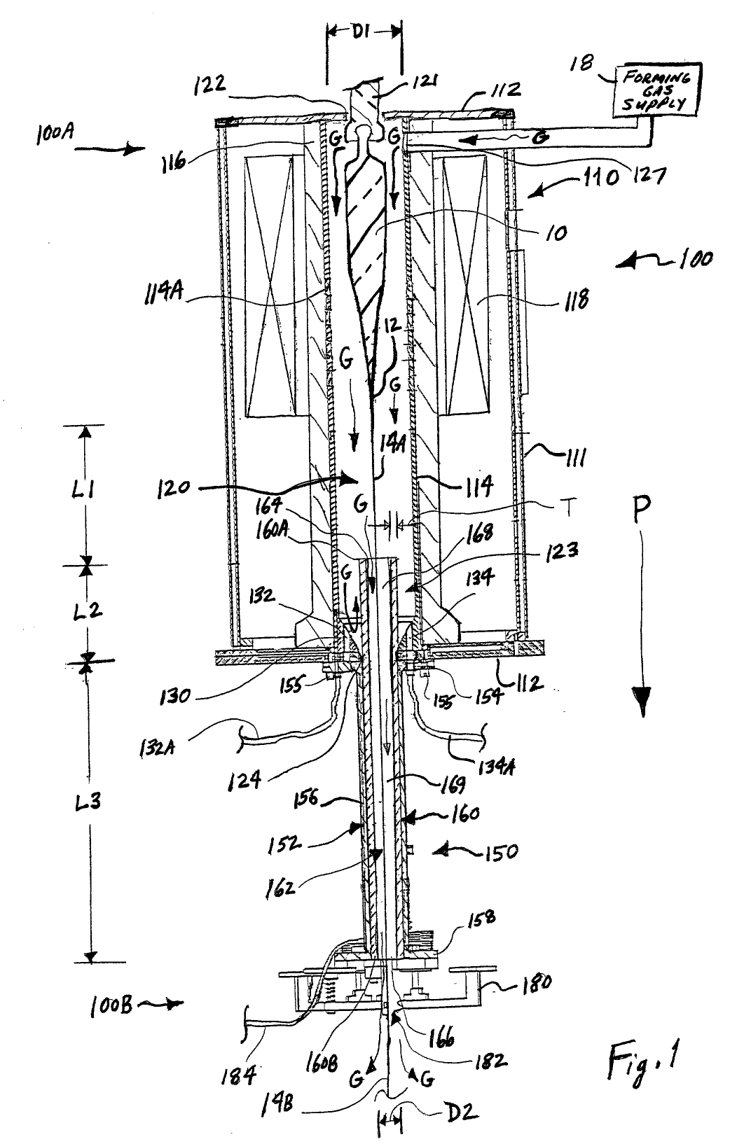

While the apparatus and methods of the preferred embodiments of the invention are described hereinbelow with reference to “upper” and “lower” orientations and relative positions and “upward” and “downward” directions, it will be appreciated that other orientations, relative positions and directions may be employed. As used herein, “upstream” and “downstream” refer to the direction of draw of the optical glass fiber and are not intended to indicate a vertical orientation. However, the vertical orientation and arrangement as illustrated in FIG. 1 is preferred.

With reference to FIG. 1, an optical fiber forming apparatus 100 according to embodiments of the present invention is shown therein. The apparatus 100 includes generally a draw furnace 110 and a diameter control assembly 150. A glass preform 10 is supplied from an upstream or upper end 100A of the assembly 100 and is heated by the draw furnace 110 such that an optical fiber 14A is drawn therefrom in a downstream direction P. The optical fiber 14A subsequently passes downstream through the diameter control assembly 150 and exits the apparatus 100 at a downstream or lower end 100B thereof as an exiting fiber 14B. Preferably, the diameter of the exiting fiber 14B is the final diameter of the finished optical fiber, exclusive of any additional coatings or the like that are added further downstream in the process.

During the drawing procedure, a forming gas G is fed into the apparatus 100 at the upper end 100A, passes downstream through the draw furnace 110 and the diameter control assembly 150, and exits the apparatus 100 at the lower end 100B. The diameter control assembly 150 serves to control the diameter of the fiber 14A by protecting the fiber 14A from turbulent flow of the forming gas G in the lower portion of the draw furnace 110.

The preform 10 may be formed of high purity silica glass and/or doped silica glass, or other suitable material. The preform 10 may be formed such that either the core or the cladding (if present) of the drawn fiber 14A is doped or such that both the core and the cladding of the drawn fiber are doped. The silica glass may be doped with germanium, fluorine, germanium and fluorine, boron, erbium, phosphorus or titanium. Other suitable dopants may be used as well. Methods and apparatus for forming the preform 10 are well known and will be understood by those of skill in the art from the description herein.

The draw furnace 110 includes a housing 111 having a lower flange 112 which may be water-cooled. An exit or lower opening 124 is defined in the lower flange 112. A hollow exit cone 130 is positioned over the opening 124. An annular susceptor tube 114 extends through the draw furnace 110 and defines an annular passage 120. The susceptor tube 114 may be formed of, for example, graphite. Lower opening 124 and a side port 127 each fluidly communicate with the passage 120. The preform is suspended in the passage 120 by handle 121 which passes through the top plate 112. An annular insulator (e.g., graphite) 116 and an induction coil 118 surround a portion of the susceptor tube 114. The induction coil 118 is arranged and operable to heat a heating section 114A of the susceptor tube 114. Auxiliary passages 132 and 134 extend through the cone 130 and are fluidly connected to hoses 132A and 134A, respectively. A forming gas supply 18 (schematically illustrated) is provided to supply the forming gas G to the passage 120 under pressure of about 1.00 atm or slightly above. The draw furnace 110, as described and illustrated above, is merely exemplary of suitable draw furnaces and those of ordinary skill in the art will appreciate the draw furnaces of other designs and constructions, for example, using other types of heating mechanisms, may be employed.

The diameter control assembly 150 includes an annular lower extended support tube 152. The support tube 152 includes a tubular section 156 defining an interior passage extending therethrough. An upper flange 154 and a lower flange 158 extend radially from opposed ends of the tubular section 156. The support tube 152 may be formed of steel or any other suitable material. The support tube 152 may also be water-cooled. The support tube 152 is secured to the lower flange 112 of the draw furnace 110 by bolts 155. Other suitable fastening means may be used as well.

The diameter control assembly 150 further includes an annular control tube 160 having an upper end 160A and a lower end 160B and extending through the support tube 152 and into the passage 120. Preferably, the control tube 160 is unitarily formed. The control tube 160 is preferably formed of quartz glass. Other suitable materials may be used; however, such materials will preferably have a melting point high enough such that the portion exposed in the furnace 110 does not melt or permanently deform when the apparatus 100 is operated.

The control tube 160 defines an interior passage 162, which fluidly communicates with each of an upper opening 164 and a lower opening 166. The diameter D2 of the passage 162 (i.e., the inner diameter of the control tube 160) is less than the corresponding diameter D1 of the passage 120. Preferably, the diameter D2 varies by no more than 25 percent along the length of the passage, and more preferably is substantially uniform (i.e., varies by no more than 5 percent), from the end 160A to the end 160B. Preferably, the diameter D2 is no greater than 100 mm, and more preferably, the diameter D2 is between about 25 and 75 mm. Preferably, the diameter D2 is no greater than 70 percent of the diameter D1. More preferably, the diameter D2 is between about 20 and 60 percent of the diameter D1.

An upper tube section 168 of the control tube 160 is disposed in the passage 120 and extends from the opening 124 (i.e., the lower end of the draw furnace 110) to the upper end 160A. The upper end 160A is disposed a distance L1 from the root tip 12 of the preform 10. As used herein, the “root tip” is the farthest upstream portion of the preform/fiber combination where the fiber is within about 130 percent of its final diameter, exclusive of coatings and the like. The distance L1 is preferably at least 100 mm, and more preferably, between about 200 and 400 mm. The outer surface of the upper tube section 168 and the adjacent, surrounding inner surface of the susceptor tube 114 define an annular, lower buffer cavity 123. The length L2 of the buffer cavity 123 is preferably at least 60 mm, and more preferably, between about 100 and 200 mm.

A lower tube section 169 extends from the opening 124 to the lower end 160B. Preferably, the lower tube section 169 has a length L3 (extending from the lower end of the buffer cavity 123 to the lower end 160B) of at least 250 mm, and more preferably, of between about 495 and 1370 mm. The preferred length L3 may depend on the fiber draw speed.

The outer diameter of the control tube 160 interfaces with the inner periphery of the cone 130 and/or the inner periphery of the lower flange 112 defining the opening 124 such that a fluid-tight seal is provided between the furnace 110 and the control tube 160 at or proximate the interface of the lower section 169 and the upper section 168 of the control tube 160. A sealing member such as an O-ring or graphite gasket may be provided at the interface.

The outer diameter of the control tube 160 is preferably substantially the same as or slightly smaller than the inner diameter of the support tube 152 so that the control tube 160 may be frictionally retained in the support tube 152. Additionally or alternatively, the control tube 160 may be retained in position by other means, such as a clamp and/or a support shelf. Spacers or an intermediate tube or sleeve may be provided between the support tube 152 and the control tube 160.

Optionally, a door assembly 180 is secured to the lower flange 158 of the support tube 152 by fasteners or other suitable means. The door assembly 180 is operable to adjust the width of a door opening 182. The door assembly 180 may be pneumatically operated, for example, using an air supply hose 184. Other types of door assemblies may be employed, suitable door assemblies being known to those of ordinary skill in the art. Preferably, the door assembly 180 is operable to adjust the size of the opening 182 to a smallest width of no more than 3 mm and to a largest width of at least 25 mm. In use, the door assembly 180 is operated to enlarge the opening 182 to a size sufficient to allow passage of a glass gob at initiation of the fiber draw, and the door assembly is thereafter operated to reduce the size of the opening 182 to a size sufficient to allow passage of the fiber 14A but to reduce the potential for the flow of air up into the opening 166.

The apparatus 100 may be used in the following manner to form the optical fiber 14B. The preform 10 is inserted into the passage 120. The induction coil 118 is operated such that the passage 120 is heated by the susceptor heating section 114A. Preferably, the tip 12 of the preform 10 is heated to a temperature of between about 1800 and 2200° C.

As the fiber 14A is thus formed, the forming gas G is fed under pressure from the supply 18 through the side port 127. The forming gas G flows down the passage 120 around the preform 10, around the tip 12 and around the fiber 14A. A portion of the forming gas G flows directly into the opening 164 of the control tube 160. A remaining portion of the forming gas G may continue down the passage 120 around the outer surface of the control tube 160, back up the passage 120, into the buffer cavity 123 and ultimately through the opening 164. After entering the opening 164, the forming gas flows through the control tube 160 and the door assembly 180 and finally exits to the ambient atmosphere.

During the fiber forming process, substantially all of the flow of the forming gas G exits through the lower control tube opening 166. Also, during the fiber forming process, substantially all of the forming gas is fed into the passage 120 and the passage 162 from a location upstream (Ie., above) the tip 12. As used herein, “substantially all of the flow of the forming gas G” means at least about 95 percent of the forming gas G that is introduced into the passage 120. A relatively small sample portion of the forming gas G may be intermittently or continuously withdrawn through the passage 132 and the hose 132A to monitor the forming gas G (for example, to monitor the O₂ or carbon monoxide content of the forming gas G). During idle periods (e.g., when a fiber is not being drawn), an inert purging gas, such as argon or helium gas, may be introduced into the passage 120 through the hose 134A and the passage 134 to inhibit the entry of oxygen into the passage 120.

During the process of forming the fiber as described above, the control tube 160 and buffer cavity 123 serves to isolate or protect the fiber 14A from turbulent eddies and instabilities in the flow of the forming gas G. Such instabilities and turbulence may cause cooling rate transients that alter the local cooling characteristics and thereby cause inconsistencies in the diameter of the fiber along its length. That is, as the fiber 14A tapers down to its ultimate diameter, the turbulence may cause differential cooling of different portions of the fiber and, as a result, different diameters. The turbulence may also exert mechanical forces on the fiber 14A that generate variations in the fiber diameter. The buffer cavity 123 and the reduced diameter D2 of the control tube 160 as compared to the diameter D1 of the passage 120 serve to reduce the exposure of the fiber 14A to forming gas turbulence. The buffer cavity 123 and the reduced diameter D2 may also provide more uniform flow of the forming gas G through the control tube 160. By providing more laminar forming gas flow, the control tube 160 and the buffer cavity 123 provide less variation in the diameter of the fiber 14A along its length.

Preferably, the flow rate of the forming gas G is between about 10 and 150 slpm. More preferably, the flow rate of the gas G is between about 18 and 47 slpm.

The forming gas G may be any suitable forming gas. Suitable gases for the forming gas G include helium, argon, nitrogen and carbon monoxide or combination thereof.

In the upper tube section 168, the fiber 14A is preferably maintained at a temperature of between about 1900 and 1600° C. In the lower tube section 169, the fiber 14A is preferably maintained at a temperature of between about 1700 and 1200° C. At the point of exiting the opening 182, the temperature of the fiber 14B is preferably between about 1500 and 1000° C. The ambient air temperature at the opening 182 is preferably about 20° C. Preferably, the fiber 14A is cooled at an average cooling rate of between about 3,000 and 15,000° C/s in the lower tube section 169.

According to further embodiments, the support tube 152 may be omitted. In this case, other suitable means may be provided for locating and supporting the control tube 160. The door assembly 180 may be omitted. A purge gas screen may be mounted adjacent the lower end of the control tube 160 to prevent or inhibit entry of ambient gases into the lower end of the control tube 160.

### EXAMPLE 1

An optical fiber was formed using an apparatus generally as described above except as follows. The apparatus did not include a diameter control assembly corresponding to the diameter control assembly 150. A lower extended muffle (LEM) was mounted on the downstream end of the draw furnace. The LEM was generally configured and mounted in the same manner as the support tube 152. The LEM had a length of about 17 inches (432 mm) and an inner diameter of about 2 inches (50 mm). The LEM was formed of stainless steel. The diameter of the furnace passage (i.e., the diameter corresponding to the diameter D1) was about 5 inches (127 mm).

Using the foregoing apparatus, the fiber was drawn at a draw speed of about 15 m/s, with a furnace temperature of about 1,880° C. and a helium forming gas provided at a flow rate of about 20 slpm.

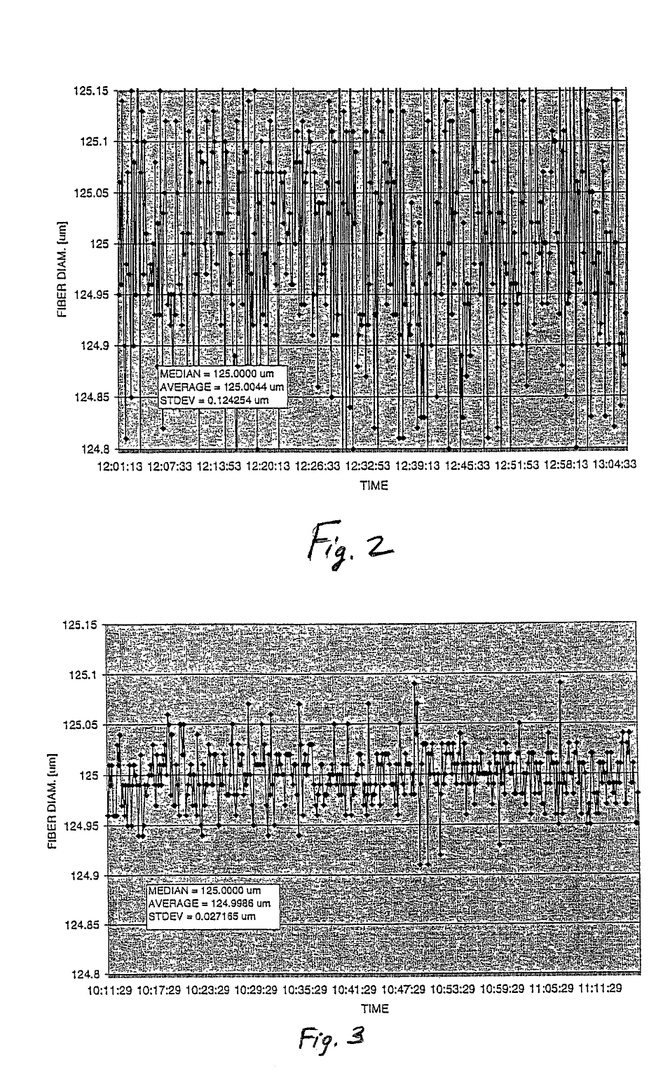

FIG. 2 is a graph representing the diameters of the fiber over time as measured by a fixed diameter sensor and correspond to the diameters of the fully drawn fiber along its length. The standard deviation in the diameters was 0.124254 μm.

### EXAMPLE 2

A second optical fiber was formed using an apparatus corresponding to the apparatus 100 described above. The length L1 was about 10 inches (254 mm), the length L2 was about 7 inches (178 mm), and the length L3 was about 20 inches (508 mm). The diameter D1 was about 5 inches (127 mm) and the diameter D2 was about 2 inches (50 mm). The fiber was drawn at a draw speed of about 15 m/s, with a furnace temperature of about 1,880° C. and a helium forming gas provided at a flow rate of about 20 slpm.

FIG. 3 is a graph representing the diameters of the fiber over time as measured by a fixed diameter sensor and correspond to the diameters of the fully drawn fiber along its length. The standard deviation in the diameters was 0.027165 μm (i.e., less than 22 percent of the standard deviation in the fiber diameters of Example 1).

Example 2 is merely exemplary of apparatus and methods according to embodiments of the present invention and the results that may be obtained therefrom and is not intended to limit the scope of the invention or the scope of the claims that follow.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An apparatus for forming optical fiber from a glass preform using a forming gas, said apparatus comprising:
a) a draw furnace having first and second opposed ends, said draw furnace defining an exit opening at said second end and a furnace passage extending between said first and second ends; and
b) a control tube extending through said exit opening of said draw furnace, said control tube defining first and second opposed tube openings and a tube passage extending between said first and second tube openings, said control tube including a first tube section and a second tube section, wherein said first tube opening and said first tube section are disposed in said furnace passage and cooperate with said furnace passage to form a buffer cavity adjacent said control tube, and wherein said second tube opening and said second tube section are disposed downstream of said draw furnace;
c) wherein said tube passage includes an inner diameter, said inner diameter of said tube passage being less than an inner diameter of said furnace passage; and
d) wherein said draw furnace and said control tube are adapted such that substantially all of the forming gas enters said furnace passage upstream of said first tube opening and exits said apparatus through said control tube.

2. The apparatus of claim 1 wherein said draw furnace and said control tube are adapted such that substantially all of the forming gas exits said apparatus through said second tube opening.

3. The apparatus of claim 1 wherein said draw furnace includes a housing and said control tube is removably secured to said housing.

4. The apparatus of claim 3 including an extended support tube defining a support tube passage, wherein said support tube is secured to said housing and at least a portion of said second tube section is disposed in said support tube passage.

5. The apparatus of claim 1 wherein said furnace includes a heating element surrounding a heating section of said furnace passage and wherein said first tube opening is disposed downstream of said heating element.

6. The apparatus of claim 1 including a door assembly disposed adjacent said second tube opening and defining a door opening, wherein said door assembly is operable to adjust a size of said door opening.

7. The apparatus of claim 1 wherein said control tube is formed of quartz glass.

8. The apparatus of claim 1 wherein said buffer cavity has a length of between about 60 and 200 mm.

9. The apparatus of claim 1 wherein said second tube section has a length of between about 250 and 1370 mm.

10. The apparatus of claim 1 wherein said inner diameter of said tube passage is substantially uniform from said first tube opening to said second tube opening.

11. The apparatus of claim 1 wherein said inner diameter of said tube passage is between about 25 and 100 mm.

12. The apparatus of claim 1 wherein said inner diameter of said tube passage is between about 20 and 70 percent of said inner diameter of said furnace passage.

13. The apparatus of claim 1 including a forming gas supply adapted to provide a flow of the forming gas into said furnace passage.

14. A method for forming an optical fiber, said method comprising:
a) providing an apparatus including:
a draw furnace having first and second opposed ends, the draw furnace defining an exit opening at the second end and a furnace passage extending between the first and second ends; and
a control tube extending through the exit opening of the draw furnace, the control tube defining first and second opposed tube openings and a tube passage extending between the first and second tube openings, the control tube including a first tube section and a second tube section, wherein the first tube opening and the first tube section are disposed in the furnace passage and cooperate with the furnace passage to form a buffer cavity adjacent the control tube, and wherein the second tube opening and the second tube section are disposed downstream of the draw furnace;
wherein the tube passage includes an inner diameter, the inner diameter of the tube passage being less than an inner diameter of the furnace passage;
b) drawing an optical glass fiber through the furnace passage and the control tube; and
c) during said step of drawing an optical glass fiber, flowing a forming gas through the furnace passage and the control tube such that substantially all of the forming gas enters the furnace passage upstream of the first tube opening and exits the apparatus through the control tube.

15. The method of claim 14 including flowing the forming gas through the furnace passage and the control tube such that substantially all of the forming gas exits the apparatus through the second tube opening.

16. The method of claim 14 including the step of placing a glass preform in the furnace passage and drawing the optical fiber from a tip of the glass preform.

17. The method of claim 16 wherein the tip is disposed upstream of the first tube opening.

18. The method of claim 17 wherein the tip is disposed a distance of between about 100 and 400 mm upstream of the first tube opening.

19. The method of claim 14 wherein the forming gas is selected from the group consisting of helium, argon, nitrogen and carbon monoxide.

20. The method of claim 14 wherein the apparatus includes a door assembly disposed adjacent the second tube opening and defining a door opening, and including the step of adjusting a size of the door opening.

21. The method of claim 14 including the step of removing a sample portion of the forming gas from the furnace passage through an auxiliary passage during said step of drawing an optical glass fiber.

22. The method of claim 14 including the step of flowing a purging gas into the furnace passage through an auxiliary passage while the optical glass fiber is not being drawn.

23. The method of claim 14 wherein the inner diameter of the tube passage is substantially uniform from the first tube opening to the second tube opening.
